(19) United States
(12) Patent Application Publication
(10) Pub. No.: US 2006/0043088 A1
(43) Pub. Date: Mar. 2, 2006

(54) Apparatus and method for a smart kitchen appliance

(76) Inventors: Bruce Ancona, New York, NY (US); Robert A. Varakian, Chicago, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/111,681

(22) Filed: Apr. 21, 2005

Related U.S. Application Data
(63) Continuation of application No. 09/809,970, filed on Mar. 16, 2001, now abandoned.
(60) Provisional application No. 60/220,001, filed on Jul. 21, 2000.

(51) Int. Cl. H05B 6/68

(52) U.S. Cl. 219/720; 219/702

(57) ABSTRACT

A method of displaying recipes on a kitchen appliance such as a blender. The appliance comprises a computing device, a display screen, and navigational keys. A server connected to the Internet may receive various recipes from a plurality of computing devices also connected to the Internet. The received recipes are converted into records having a consistent record format and stored in a database, and the records are then communicated to the appliance. Optionally the recipe data may be inserted into the appliance in the form of a chip or other computing device. A selection of various criteria is presented on the display screen of the appliance and the user uses navigational keys to select criteria for sorting of the records. The records are then sorted according to the selected criteria, and the sorted records are listed on the display screen. Using the navigational keys the user selects and displays at least one recipe on the display screen, after which a next or previous recipe on the sorted list may be displayed using the navigational keys.

### RELATED APPLICATION

This application claims the benefit of U.S. Provisional Application 60/220,001, filed Jul. 21, 2000.

### BACKGROUND OF THE INVENTION

1. Field of the Invention

This invention relates to a smart kitchen appliance. More particularly, this invention elates to a kitchen appliance capable of displaying information regarding food or drink preparation, recipes and/or caloric content.

2. Background of the Invention

Recipes, too numerous to count, for food and drink preparation have been extensively published. Recipes are usually published in books or pamphlets, and lately recipes are available to professional and amateur cooks all over the world on various websites and in digital files on the Internet. Recipes indicate exact amounts or weights of specific ingredients to be used, to make the food or drink being prepared adhere to consistent texture, taste, and color. Recipes are invaluable especially where precise amounts of ingredients have to be used.

Electric blender appliances are used in millions of households throughout the world to hasten food and drink preparation. To use a recipe, the user of the blender appliance has to have the particular book, pamphlet or the digital file available at the time of food or drink preparation. This means that the user must spend time not only in preparing the ingredients but also in looking for and finding the appropriate recipe, which is usually inconvenient and wasteful of time. Moreover, if at the time of food preparation the user changes his/her mind as to what is being prepared, a new recipe must be found. Also, if a recipe book or pamphlet is open, ingredients from the blender could be spilled on the recipe.

A number of kitchen appliances having an electronic control means are known. Such appliances include, for example, the device described in U.S. Pat. No. 4,649,810, which discloses a computer-controlled integrated cooking apparatus for automatically preparing a culinary preparation according to a predetermined recipe program. The recipe program specifies schedules for dispensing the ingredients. The microcomputer system of the apparatus is also capable of storing recipes, displaying a listing of ingredients, or giving special instructions for a particular recipe. A similar apparatus is disclosed in U.S. Pat. No. 5,819,636, where a food processor similar to the aforementioned apparatus comprises a microprocessor for controlling the apparatus for adding, stirring, blending, or heating the ingredients in a recipe.

Similarly, the U.S. Pat. No. 5,704,277 discloses a bread-maker or a program-controlled machine of a similar kind adapted to operate according to one of a plurality of recipe programs provided, which programs are each identified by a code. The code selected corresponds to pre-packaged ingredients. The machine may include a memory device which stores many programs and may be considered to be part of a CPU serving as a control means for the general operation of the device.

These devices are complicated and are limited in the number of recipes that they can use. Moreover, there is still the problem of access to a plurality of recipes and the time spent in selecting or choosing one remains. There is a definite need for a device capable of providing a recipe immediately available to the user without any time spent searching through publications.

### OBJECTS OF THE INVENTION

It is an object of the invention to provide a smart kitchen appliance and a method of using same.

It is also an object of the invention to provide a blender appliance capable of displaying recipes and/or other information.

It is a further object of the invention to provide a method for displaying recipes or other information on a blender appliance.

These and other objects of the invention will become more apparent from the discussion below.

### SUMMARY OF THE INVENTION

According to the invention, recipes or other information is displayed on a kitchen appliance such as a blender. The appliance preferably comprises an imbedded computing device or chip, a display screen, and navigational keys. It can optionally be connected to the Internet or can accept computer readable medium, e.g., diskettes and/or CDs. Other kitchen appliances within the scope of the invention include slow cookers, pasta makers, food processors, bread makers, small ovens, toaster ovens, and the like.

First, the recipes, or other information are collected in a database on a server. The server is connected to the Internet, whereupon it receives various recipes or other information from a number of computing devices or websites, which are also connected to the Internet. The received information is converted into records having a consistent record format and is stored in the database. A selection of the records picked by a user, e.g., according to a subscription, is then communicating to the blender appliance. This can be achieved by sending the selection of the records to the user's computing device which needs to also be connected to the Internet, or directly to the computing devise imbedded in the blender appliance which may also be connected to the Internet. Alternatively, the selection of the records may be stored on medium readable by the computing device imbedded in the blender, e.g., diskettes, CDs, etc.

Once the selection of the records is loaded into or imbedded in the appliance of the invention, a choice of various criteria for organizing such a selection of records is presented on the display screen of the blender appliance, and the user, using navigational keys of the computing device imbedded in the blender appliance, chooses the criteria for sorting of the records. The records are then sorted according to the chosen criteria and the sorted records are listed on the display screen. Using the navigational keys the user chooses at least one recipe and displays it on the display screen. After viewing a chosen recipe the user may display a next or previous recipe from the sorted list of recipes using the navigational keys.

### BRIEF DESCRIPTION OF DRAWINGS

The foregoing objects and advantages of the present invention may be more readily understood by one skilled in the art with reference being had to the following detailed description of a preferred embodiment thereof, taken in conjunction with the accompanying drawings wherein like elements are designated by identical reference numerals throughout the several views, and in which:

FIG. 1 is a pictorial representation of the environment of the networked computing devices utilized for the present invention;

FIG. 2 is a pictorial representation of the hardware components of the computing devices utilized for the present invention;

FIG. 3; is a record format used to for records and the database of the present invention.

FIGS. 4a and 4b are representations of embodiments of a preferred blender embodiment useful according to the invention;

FIG. 4c is an exploded view of the embodiment shown in FIG. 4b;

FIG. 5 is a flowchart describing the steps of selecting and displaying recipes on an appliance of the present invention; and

FIG. 6 is an example of a sorted record list used to enable selection of a recipe by a user of the present invention.

### DETAILED DESCRIPTION OF THE INVENTION

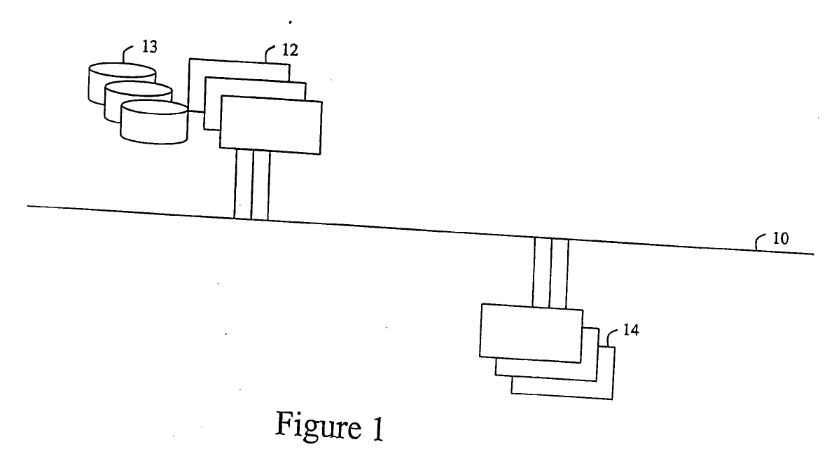

As shown in FIG. 1, the present invention collates recipes in recipe collection databases 13 managed by computing devices 12. Computing devices 14 may be kitchen appliances of the present invention or intermediary computing devices interfacing with a microprocessor installed in the blender appliance. Computing devices 14 may then retrieve a plurality of such recipes via the network 10 and provide or forward them to the blender appliance of the present invention. This can be accomplished by using commonly available Internet-based browser programs, e.g., Microsoft Explorer™ and Netscape Navigator™.

In an alternative embodiment the recipes may be provided directly to the kitchen appliance on a computer readable devices, e.g., diskettes, compact discs (CDs), or digital video disks (DVDs), smart card devices, Peripheral Component Microchannel Interconnect Architecture (PCMCIA) cards, programmable read only memory (PROM), and other types of computer memory.

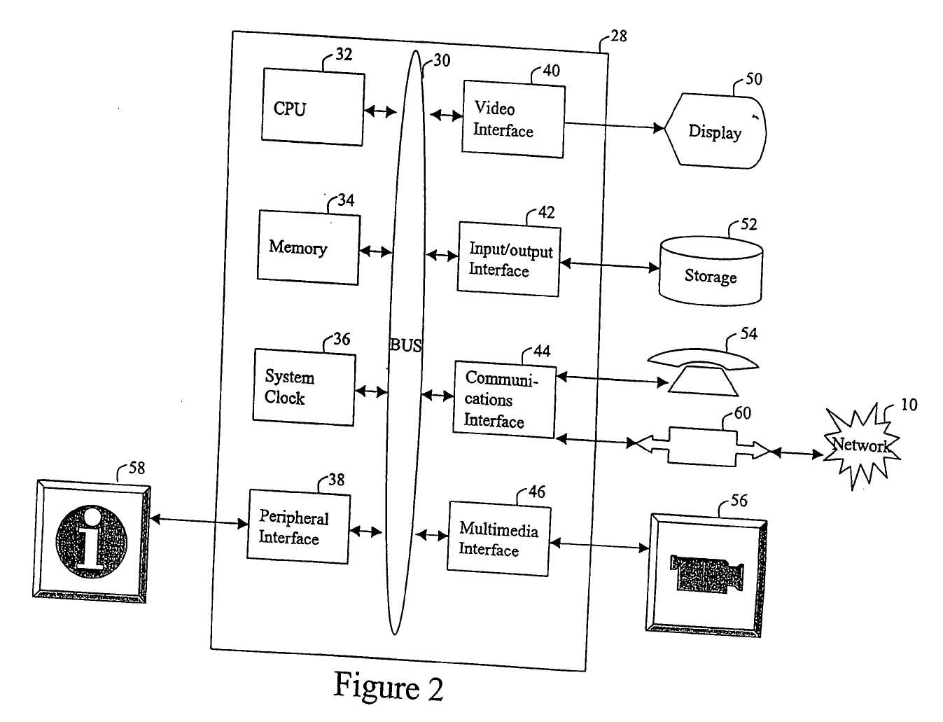

The computing devices 12 and 14 may illustratively take the configuration of any computer ranging from mainframes to personal computers (PCs). In one illustrative embodiment of this invention as shown in FIG. 2, such computing devices may comprise a bus 30, which is connected directly to a central processing unit (CPU) 32; a memory 34; a system clock 36; a peripheral interface 38; a video interface 40; an input/output (I/O) interface 42; a communications interface 44; and a multimedia interface 46.

The common bus 30 is further connected as follows

(a) by the video interface 40 to a display 50;

(b) by the I/O interface 42 to a storage device 52, which may illustratively take the form of memory gates, disks, diskettes, compact disks (CD), digital video disks (DVD), etc.;

(c) by the multimedia interface 46 to any multimedia component 56;

(d) by a peripheral interface 38 to the peripherals 58, such as the keyboard, the mouse, navigational buttons, e.g., on a digital phone, a touch screen, and/or a writing screen on full size and hand held devices, e.g., a Palm Pilot™;

(e) by the communications interface 44, e.g., a plurality of modems, to a network connection 60, e.g., an Internet Service Provider (ISP), and to other services, which is in turn connected to the network 10, whereby a data path is provided between the network 10 and other computing devices and, in particular, the common bus 30 of these computing devices; and

(f) furthermore, by the communications interface 44 to a wired and/or a wireless telephone system 54.

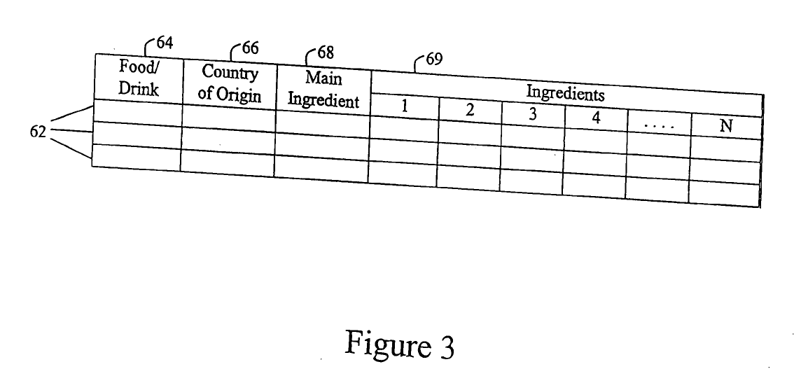

FIG. 3 represents the record format of the recipe database 13 (FIG. 1). Each recipe of the inventive database may make up a separate record 62 and comprises main keys including a food or drink identification key 64, a country of origin and/or food/drink name identification key 66, and a main ingredient identification key 68. A time of preparation can be included in the main ingredient field or as a separate identification key. Remaining ingredients of the recipe and amounts prescribed for use with the recipe are listed in the ingredient fields 69.

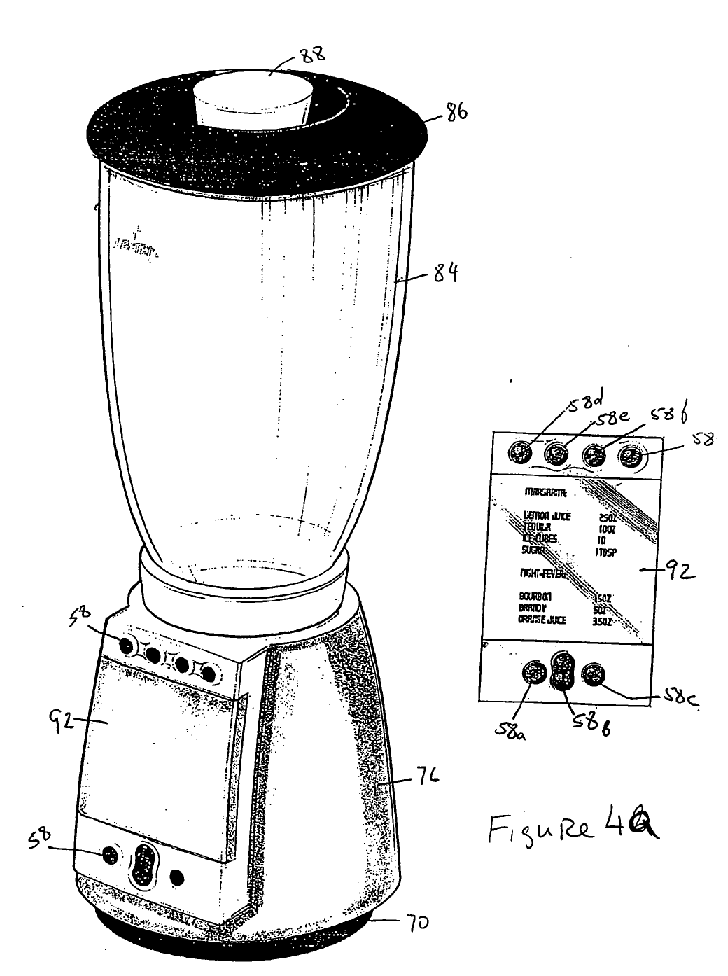

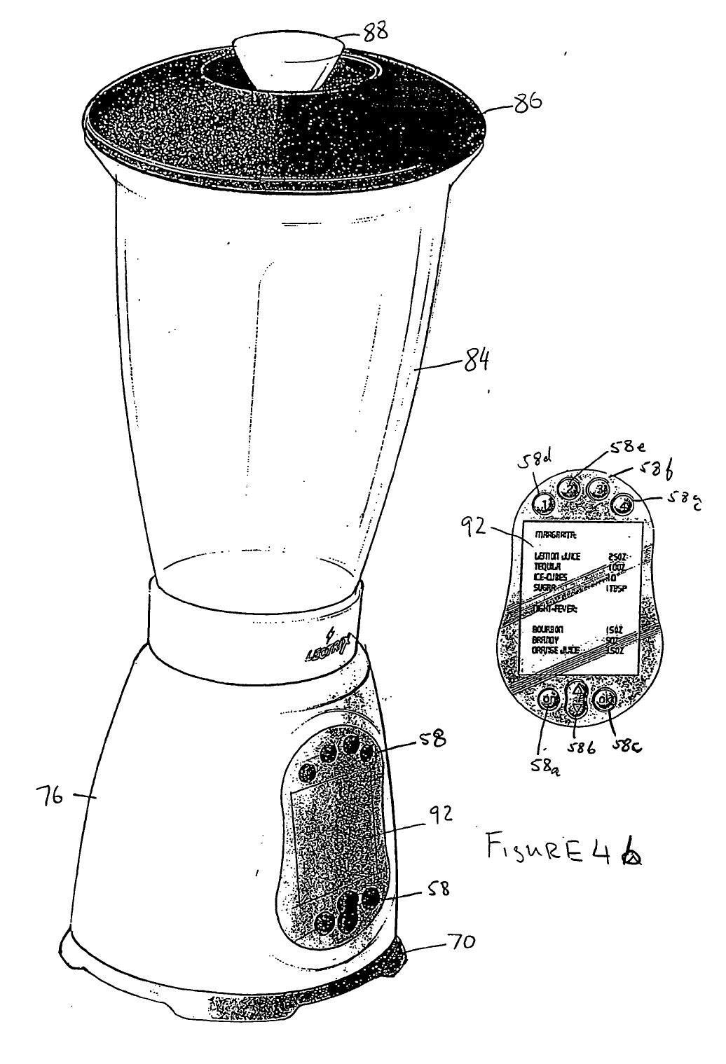

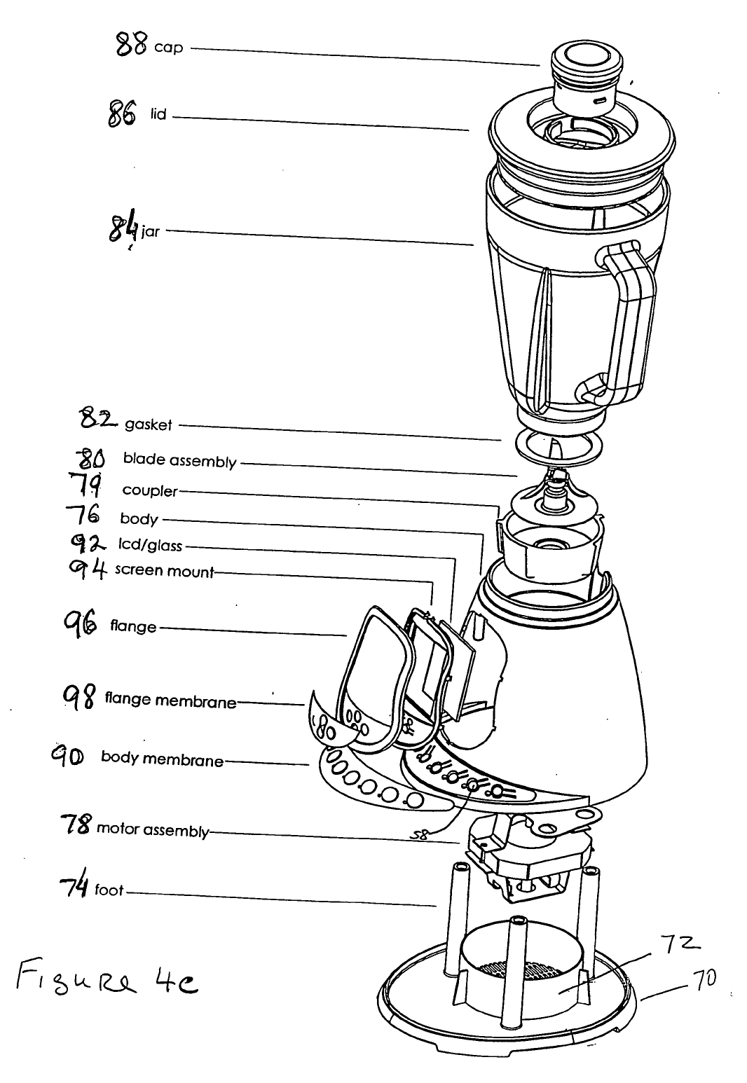

Embodiments of the preferred blender appliance of the invention are shown in FIGS. 4a and 4b. In FIG. 4c, the blender appliance comprises a base 70 with a motor assembly hub 72 thereon. The hub 72 is surrounded by a plurality of feet 74 for fastening a body 76 to the base 70. The motor assembly 78 is placed into the hub 72. The body 76 is placed over the motor assembly 78 and fastened to the plurality of feet 74.

A coupler 79 is arranged in a manner as to attach a blade assembly 80 to the motor assembly 78. A gasket 82 is then placed on top of the blade assembly 80 to create a seal between the coupler 79 and a jar 84, which is placed on top of the gasket 82. A lid 86 may then be used to cover the jar 84, and a cap 88 may then be removably placed in the opening of the lid 86.

A computing device 28 (FIG. 2) may then be placed within the body 76 partially occupied by the motor assembly 78. The computing device 28 (FIG. 2) is controlled by keys 58, which in the present embodiment are covered by a body membrane 90. Any output produced by the computing device 28 (FIG. 2) will be displayed on a display device 50 (FIG. 2) which is covered by a liquid crystal display (LCD) glass 92. A screen mount 94 covers the glass 92 to keep it firmly in place against the body 76. A flange 96 covers the screen mount 94 and a flange membrane 98 covers the lower portion of the flange 96.

In FIGS. 4a and 4b, the blender appliance is shown comprising the body 76, which is placed over and covering the motor assembly 78 (FIG. 4c) and the computing device 28 (FIG. 2) of the present invention. The body is fastened to the base 70. The jar 84, covered by the lid 86 including the removable cap 88 is attached to the motor assembly 78 (FIG. 4c) and thereby to the body 84 by a coupler 79 (FIG. 4c).

The computing device 28 (FIG. 2) located within the body 76 may be operated or controlled by control keys 58a-58g, any output produced by the computing device 28 (FIG. 2) will be displayed on a display device 50 (FIG. 2) which in this illustrative embodiment is represented by the LCD 92. Furthermore in this illustrative embodiment, an on key 58a is used to turn the blender apparatus, including the motor assembly 78 (FIG. 4c) and the computing device 28 (FIG. 2) on and off. Alphanumeric keys 58d-58g are used to make selections from a menu of numbered choices displayed on the LCD 92. Alternatively a navigational key 58b may be used to navigate or scroll through the menu of choices displayed on the LCD 92, where the current choice may be indicated, e.g., by highlighting, and an OK key 58c is used to select the indicated choice. Optionally keys 58d-58g could be speed controls and/or additional alphanumeric keys may be present for entering data or selecting recipes.

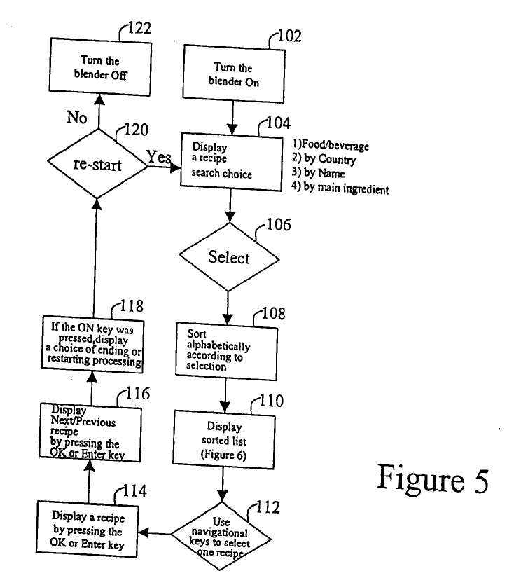

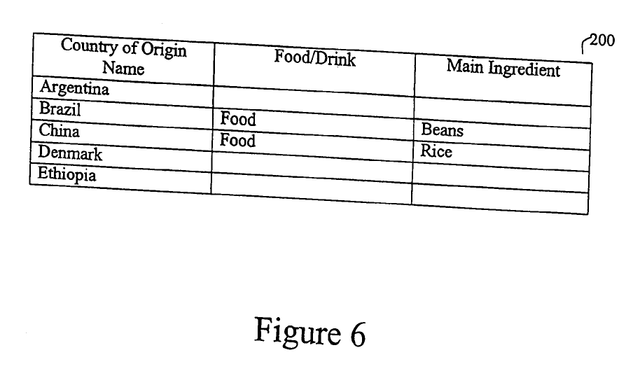

In one illustrative embodiment, shown in FIG. 5, the invention operates according to a process 100. It is appreciated that one skilled in the art could have used other methods without departing from the scope of the invention. After the On key 58a (FIGS. 4a and 4b) is pressed in step 102, a menu of options is displayed in step 104 on the screen 92 (FIGS. 4a and 4b). In step 108 all the recipe records 62 (FIG. 3) are alphabetically sorted according to the selection made in step 106 by the pressing the alphanumeric keys 58d-58g (FIGS. 4a and 4b). The sorted list of recipes is then displayed in step 110 on the screen 92 (FIGS. 4a and 4b). An example of such sorted list is presented in FIG. 6.

In step 112, the user may use the up and down navigational key 58b (FIGS. 4a and 4b) to chose a particular recipe from the list and then, in step 114 display the recipe on the screen 92 (FIGS. 4a and 4b) by pressing the OK key 58c (FIGS. 4a and 4b). In step 116 the user may display recipes located immediately above or below of the recipe currently being displayed in the list 200 (FIG. 6).

If the user decides to abandon the present processing mode by pressing the On key 58a, in step 118 he/she will be presented with a choice of ending processing or selecting a different display criteria. The user may make a choice in step 120 by selecting an entry with the navigational key 58b and then pressing the OK key 58c. Alternatively the alphanumerical keys 58d-58g may be used. If the user decides to terminate the process 100, the blender appliance will be turned off in step 122. Otherwise, the processing will continue in step 104.

While the invention has been particularly shown and described with respect to illustrative and preferred embodiments thereof, it will be understood by those skilled in the art that the foregoing and other changes in form and details may be made therein without departing from the spirit and scope of the invention that should be limited only by the scope of the appended claims.

What is claimed is:

1. A method of displaying at least one recipe on a kitchen appliance, the kitchen appliance comprising a computing device and a display screen, said method comprising the steps of:
(a) communicating a plurality of records to the kitchen appliance, each of said plurality of records comprising the at least one recipe;
(b) listing said plurality of records on the display screen according to a criteria; and
(c) displaying the at least one recipe on the display screen.

2. The method of claim 1, further comprising the steps of:
selecting said criteria for sorting said plurality of records from a selection presented on the display screen using navigational keys; and
sorting said plurality of records according to said selected criteria.

3. The method of claim 2, further comprising a step of selecting the at least one recipe from said plurality of records listed on the display screen, said selecting is performed using said navigational keys.

4. The method of claim 3, further comprising a step of displaying a next or a previous of the at least one recipe on the display screen, said displaying being performed using said navigational keys.

5. The method of claim 1, further comprising the steps of
at least one server computing device receiving said at least on recipe from a plurality of computing devices connected to a network;
converting said received at least on recipe in to said plurality of records, said plurality of records having a consistent record format; and
storing said plurality of records in a database.

6. The method of claim 5, further comprising the step of communicating said plurality of records to the blender appliance from said at least one server computing device via said network.

7. The method of claim 6, further comprising the step of communicating said plurality of records to the blender appliance a computer readable medium.

8. The method of claim 7, wherein said network is the Internet.

9. The method of claim 1, wherein the kitchen appliance is a blender.

10. A kitchen appliance for displaying information, said kitchen appliance comprising:
a computing device for accepting a plurality of records, each of said plurality of records comprising the at least one recipe; and
a display screen for listing said plurality of records according to a criteria, and displaying the information.

11. The kitchen appliance of claim 10, where the information is at least one recipe.

12. The kitchen appliance of claim 11, further comprising navigational keys for selecting said criteria for sorting said plurality of records from a selection presented on said display screen; and sorting said plurality of records according to said selected criteria.

13. The kitchen appliance of claim 12, wherein said navigational keys further used for selecting said at least one recipe from said plurality of records listed on said display screen and for displaying a next or a previous of said at least one recipe on said display screen.

14. The kitchen appliance of claim 13, further comprising a network connection for receiving said at least on recipe from a plurality of computing devices connected to a network.

15. The kitchen appliance of claim 14, wherein said network is Internet.

16. The kitchen appliance of claim 15, further comprising a computer medium reader for receiving said at least on recipe on such computer medium.

17. The kitchen appliance of claim 10 which is a blender.
